(19) United States
(12) Patent Application Publication
(10) Pub. No.: US 2014/0315548 A1
(43) Pub. Date: Oct. 23, 2014

(54) METHODS AND APPARATUS FOR ACCESS CLASS BARRING FOR VOIP CALLS

(71) Applicant: QUALCOMM INCORPORATED, San Diego, CA (US)

(72) Inventors: Shyamal RAMACHANDRAN, San Diego, CA (US); Kiran KishanRao PATIL, San Diego, CA (US); Nitin PANT, San Diego, CA (US); Bhupesh Manoharlal UMATT, Poway, CA (US)

(73) Assignee: QUALCOMM INCORPORATED, San Diego, CA (US)

(21) Appl. No.: 14/257,145

(22) Filed: Apr. 21, 2014

Related U.S. Application Data
(60) Provisional application No. 61/814,666, filed on Apr. 22, 2013.

(51) Int. Cl. H04W 48/16; H04W 48/10

(52) U.S. Cl. CPC H04W 48/16; H04W 48/10
USPC 455/434

(57) ABSTRACT

Certain aspects of the present disclosure relate to methods and apparatus for transmission restriction. An exemplary method generally includes initiating a mobile originating (MO) call, determining availability of parameters for a first access gating mechanism for determining whether to bar or allow transmission of the MO call, selecting the first access gating mechanism or a second access gating mechanism, based on the determination of the availability of the parameters, and applying the selected gating mechanism to determine whether to bar or allow the MO call.

### CROSS-REFERENCE TO RELATED APPLICATIONS

This application claims priority under 35 U.S.C. §119(e) to U.S. Provisional Patent Application Ser. No. 61/814,666 entitled METHODS AND APPARATUS FOR ACCESS CLASS BARRING FOR VOIP CALLS, filed on Apr. 22, 2013, the content of which is hereby incorporated by reference herein in its entirety for all purposes.

### FIELD

The present disclosure relates generally to communication systems, and more particularly, to methods and apparatus for access class barring for Voice over Internet Protocol (VoIP) calls.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE/LTE-Advanced is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

A wireless communication network may include a number of base stations that can support communication for a number of user equipments (UEs). A UE may communicate with a base station via the downlink and uplink. The downlink (or forward link) refers to the communication link from the base station to the UE, and the uplink (or reverse link) refers to the communication link from the UE to the base station.

### SUMMARY

Certain aspects of the present disclosure provide a method for wireless communications by a user equipment (UE). The method generally includes determining availability of parameters for a first access gating mechanism for determining whether to bar or allow transmission of a mobile originated (MO) call, selecting the first access gating mechanism or a second access gating mechanism, based on the determination, and applying the selected gating mechanism to determine whether to bar or allow the MO call.

Certain aspects of the present disclosure provide an apparatus for wireless communications by a user equipment (UE). The apparatus generally includes means for determining availability of parameters for a first access gating mechanism for determining whether to bar or allow transmission of a mobile originated (MO) call, means for selecting the first access gating mechanism or a second access gating mechanism, based on the determination, and means for applying the selected gating mechanism to determine whether to bar or allow the MO call.

Certain aspects of the present disclosure provide an apparatus for wireless communications by a user equipment (UE). The apparatus generally includes at least one processor configured to determine availability of parameters for a first access gating mechanism for determining whether to bar or allow transmission of a mobile originated (MO) call, select the first access gating mechanism or a second access gating mechanism, based on the determination, and apply the selected gating mechanism to determine whether to bar or allow the MO call.

Certain aspects of the present disclosure provide a computer program product for wireless communications by a user equipment (UE). The computer program product generally includes a computer readable medium having instructions stored thereon, the instructions executable by one or more processors for determining availability of parameters for a first access gating mechanism for determining whether to bar or allow transmission of a mobile originated (MO) call, selecting the first access gating mechanism or a second access gating mechanism, based on the determination, and applying the selected gating mechanism to determine whether to bar or allow the MO call.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control plane.

FIG. 6 is a diagram illustrating an example of an evolved Node B and user equipment in an access network, in accordance with certain aspects of the disclosure.

FIG. 7 is a diagram illustrating an example of a radio protocol architecture for the user and control plane with example access gates, in accordance with certain aspects of the disclosure.

FIG. 8 illustrates example operations performed by a user equipment (UE), in accordance with certain aspects of the present disclosure.

FIG. 9 illustrates example operations for wireless communications performed by a user equipment (UE), in accordance with certain aspects of the present disclosure.

FIG. 10 illustrates example operations for wireless communications performed by a user equipment (UE) using a modified access class blocking or barring (ACB) procedure, in accordance with certain aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using hardware, software/firmware, or combinations thereof Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software/firmware, middleware, microcode, hardware description language, or otherwise.

Accordingly, in one or more exemplary embodiments, the functions described may be implemented in hardware, software/firmware, or combinations thereof If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

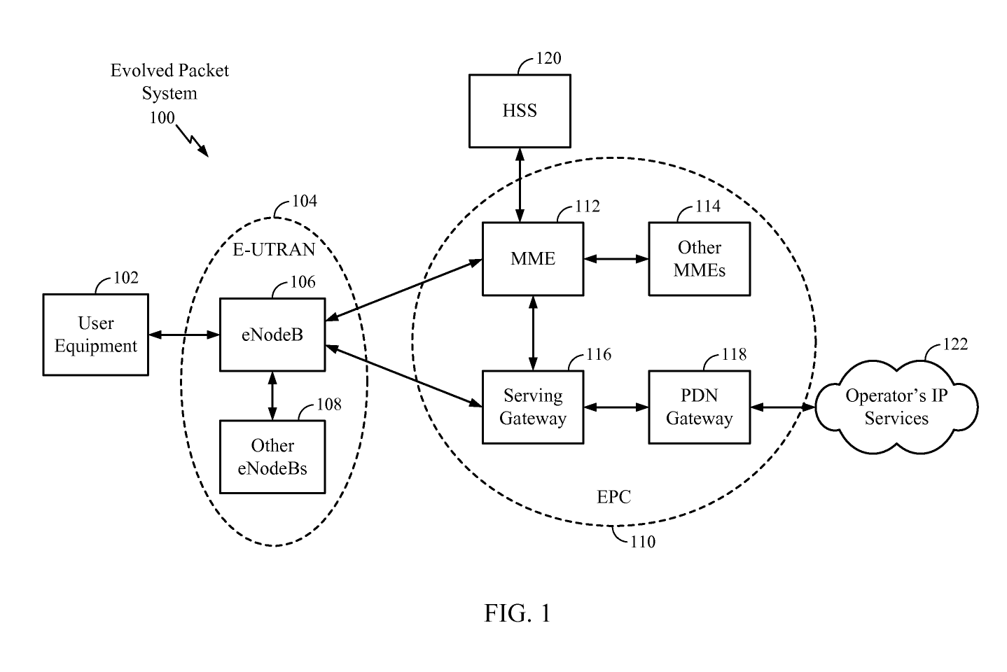

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's IP Services 122. The EPS can interconnect with other access networks, but for simplicity those entities/interfaces are not shown. Exemplary other access networks may include an IP Multimedia Subsystem (IMS) PDN, Internet PDN, Administrative PDN (e.g., Provisioning PDN), carrier-specific PDN, operator-specific PDN, and/or GPS PDN. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108. The eNB 106 provides user and control plane protocol terminations toward the UE 102. The eNB 106 may be connected to the other eNBs 108 via an X2 interface (e.g., backhaul). The eNB 106 may also be referred to as a base station, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a netbook, a smart book, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected by an 51 interface to the EPC 110. The EPC 110 includes a Mobility Management Entity (MME) 112, other MMEs 114, a Serving Gateway 116, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include, for example, the Internet, the Intranet, an IP Multimedia Subsystem (IMS), and a PS Streaming Service (PSS). In this manner, the UE102 may be coupled to the PDN through the LTE network.

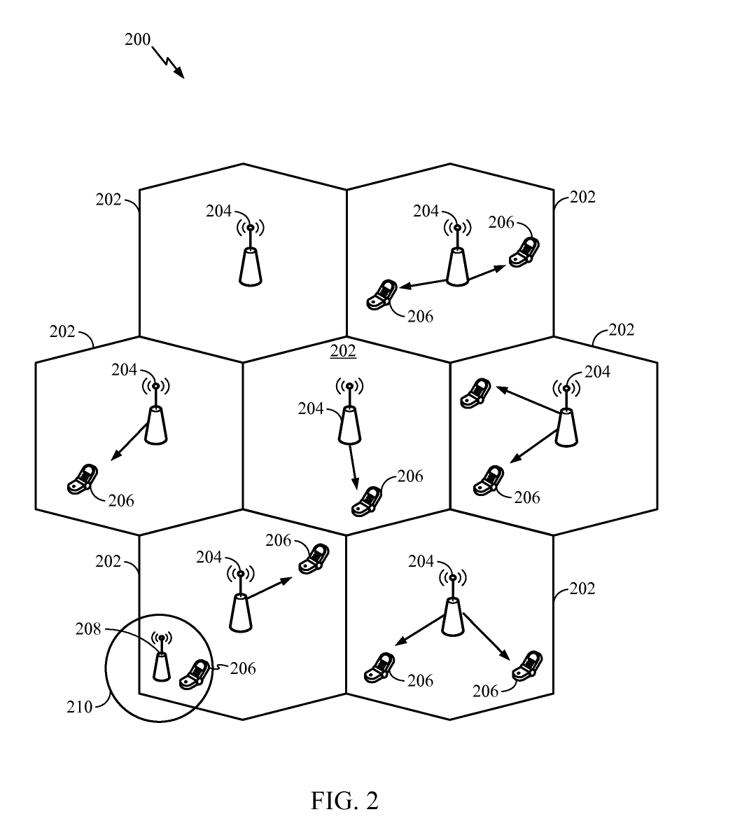

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. A lower power class eNB 208 may be referred to as a remote radio head (RRH). The lower power class eNB 208 may be a femto cell (e.g., home eNB (HeNB)), pico cell, or micro cell. The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116.

The modulation and multiple access scheme employed by the access network 200 may vary depending on the particular telecommunications standard being deployed. In LTE applications, OFDM is used on the DL and SC-FDMA is used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data streams may be transmitted to a single UE 206 to increase the data rate or to multiple UEs 206 to increase the overall system capacity. This is achieved by spatially precoding each data stream (e.g., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

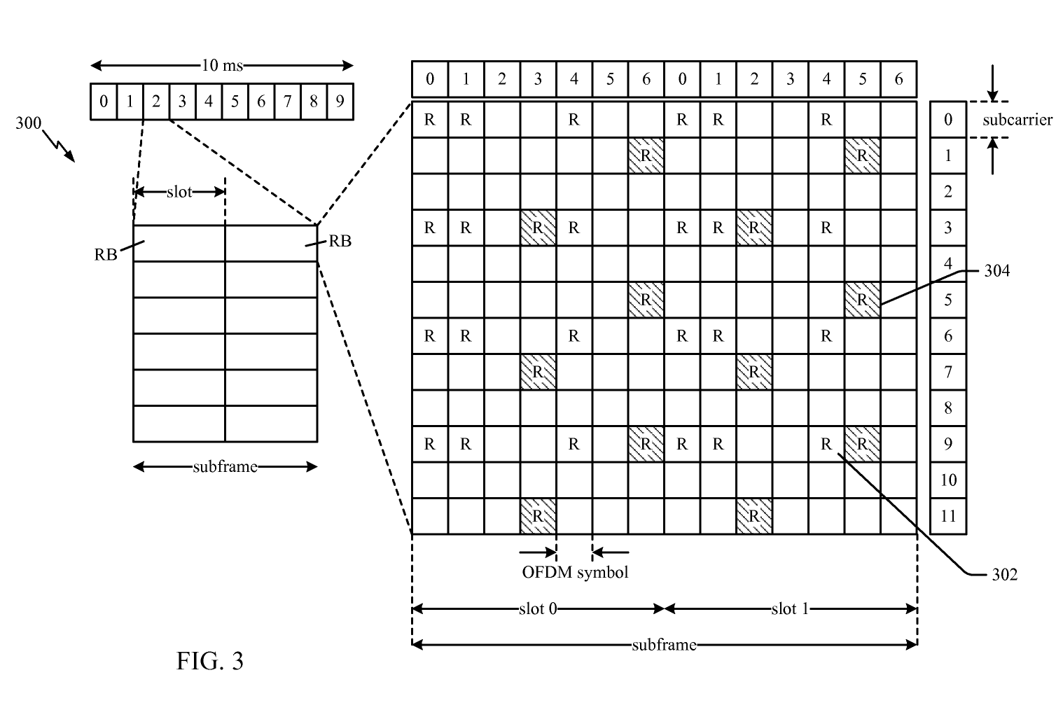

FIG. 3 is a diagram 300 illustrating an example of a DL frame structure in LTE. A frame (10 ms) may be divided into 10 equally sized sub-frames with indices of 0 through 9. Each sub-frame may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

In LTE, an eNB may send a primary synchronization signal (PSS) and a secondary synchronization signal (SSS) for each cell in the eNB. The primary and secondary synchronization signals may be sent in symbol periods 6 and 5, respectively, in each of subframes 0 and 5 of each radio frame with the normal cyclic prefix (CP). The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Physical Control Format Indicator Channel (PCFICH) in the first symbol period of each subframe. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. The eNB may send a Physical HARQ Indicator Channel (PHICH) and a Physical Downlink Control Channel (PDCCH) in the first M symbol periods of each subframe. The PHICH may carry information to support hybrid automatic repeat request (HARQ). The PDCCH may carry information on resource allocation for UEs and control information for downlink channels. The eNB may send a Physical Downlink Shared Channel (PDSCH) in the remaining symbol periods of each subframe. The PDSCH may carry data for UEs scheduled for data transmission on the downlink.

The eNB may send the PSS, SSS, and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH, and PHICH in a broadcast manner to all UEs, may send the PDCCH in a unicast manner to specific UEs, and may also send the PDSCH in a unicast manner to specific UEs.

A number of resource elements may be available in each symbol period. Each resource element (RE) may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1, and 2. The PDCCH may occupy 9, 18, 36, or 72 REGs, which may be selected from the available REGs, in the first M symbol periods, for example. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search.

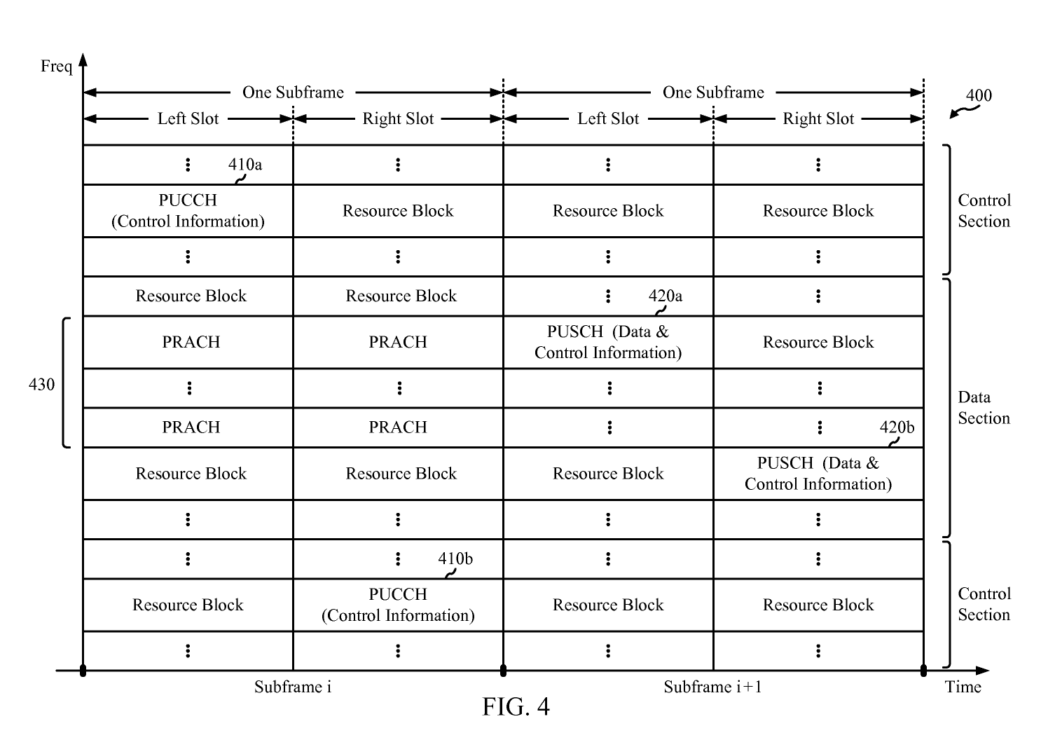

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

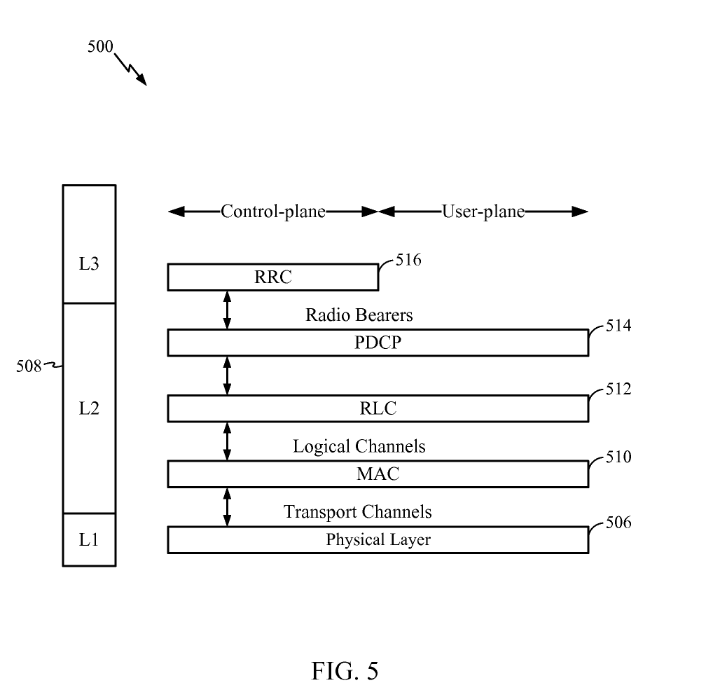

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (i.e., radio bearers) and for configuring the lower layers using RRC signaling between the eNB and the UE.

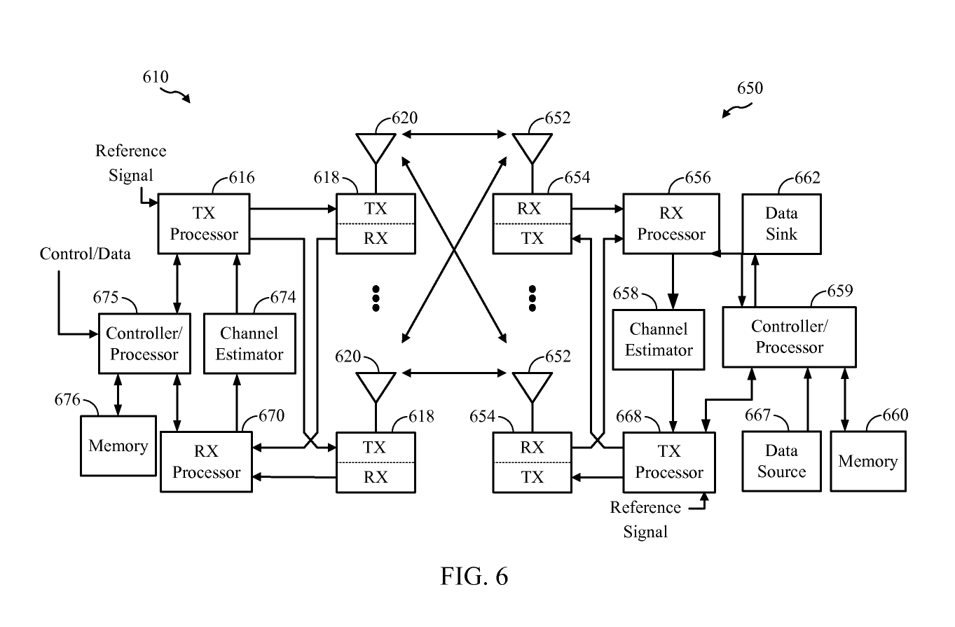

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The TX processor 616 implements various signal processing functions for the L1 layer (i.e., physical layer). The signal processing functions includes coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream is then provided to a different antenna 620 via a separate transmitter 618TX. Each transmitter 618TX modulates an RF carrier with a respective spatial stream for transmission.

At the UE 650, each receiver 654RX receives a signal through its respective antenna 652. Each receiver 654RX recovers information modulated onto an RF carrier and provides the information to the receiver (RX) processor 656. The RX processor 656 implements various signal processing functions of the L1 layer. The RX processor 656 performs spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the control/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 are provided to different antenna 652 via separate transmitters 654TX. Each transmitter 654TX modulates an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the control/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

### Example Access Class Barring for VoIP Calls

Aspects of the present disclosure provide techniques and apparatus for access class barring for Voice over Internet Protocol (VoIP) calls.

Current state of certain standards (e.g., 3GPP specifications) with regard to access barring for VoIP calls, such as Voice over LTE (VoLTE) calls, is incomplete. An operator can block all PS data call and VoLTE calls or block VoLTE calls, yet allow all PS data call. Unfortunately, under current standards, an operator may not be able to block all PS data calls, yet allow VoLTE calls.

Thus, there may be no way for a network to block all user data and yet allow VoLTE and/or video telephony (VT) calls. In other words, currently, VoLTE/VT services are fundamentally treated at par with other forms of data. However, this may not be appropriate in scenarios where the operator wants to allow voice calls and block all forms or data sessions (e.g., browsing, social media, FTP, streaming video etc.), assuming that the voice technology deployed is VoIP. It may be noted that 3GPP standards define a feature referred to as service specific access control (SSAC). However, SSAC achieves the opposite effect: it blocks Voice and VT calls, while allowing other forms of user data.

Therefore, there may be a need for a solution where the operator can allow users to make VoLTE calls and disallow all other types of user data exchange.

According to certain aspects of the present disclosure, a UE may be configured to allow VoIP calls (e.g., VoLTE/VT calls), while still disallowing other types of user data exchange. In some cases, this may be accomplished through a combination of two separate blocking mechanisms (referred to herein as “gates”). As will be described, when (and possibly how) a second gate is applied may depend on whether the first gate is applied.

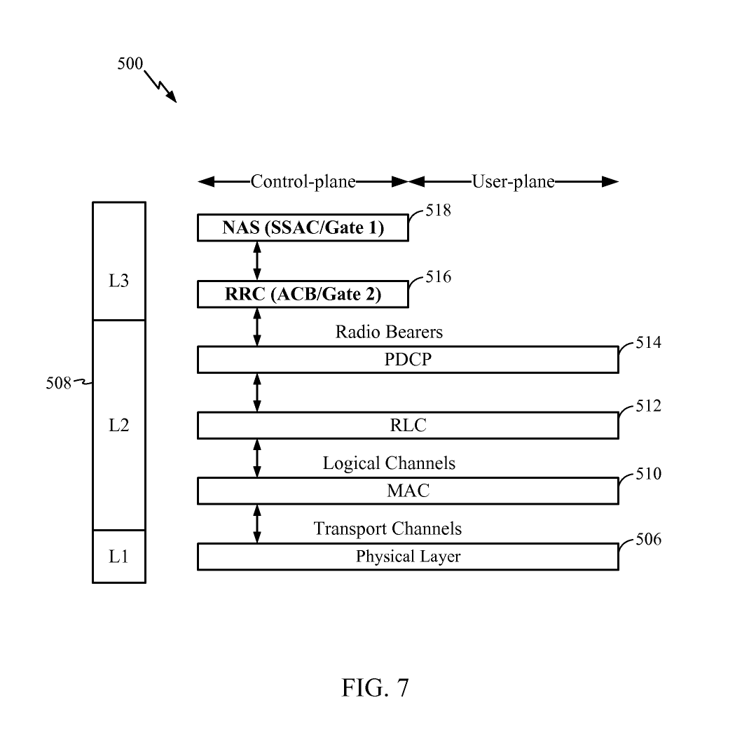

For example, referring to FIG. 7, a first gate may be applied in a Non-Access Stratum (NAS) layer 518. This first gate may correspond to SSAC and may be incorporated in a multi-media/telephony (MMTEL) component that determines how to handle telephony calls (e.g., dialing, VoLTE/VT calls).

A second gate may be applied in the RRC layer 516. This second gate may correspond to ACB. As will be described in greater detail below, in some cases, when and how this second gate is applied may depend on whether or not parameters for the first gate are available. For example, only Gate 1 may be applied when SSAC parameters are broadcast (e.g., in SIB2). On the other hand, Gate 2 may be applied when SSAC parameters are not broadcast.

Operators may configure the gate mechanisms, for example, by broadcasting parameters for different access classes (ACs) that a UE may use to decide when to allow a call. For example, each UE may be assigned an AC value and, when initiating a call, may generate a random number to be compared against a parameter broadcast (a “barring rate”) for that AC value. As an example, a UE with AC value of 0 may receive a broadcast value of 0.6. When deciding whether to transmit, the UE may generate a random value between 0 and 1 and, if that value is equal to or greater than 0.6, the UE may transmit. Otherwise, the UE may refrain from transmitting/broadcasting for a duration value that determines how long the transmissions should be barred.

Thus, in certain cases when it is desirable to limit certain types of transmissions (e.g., in an emergency situation where resources could be easily overloaded with calls) an operator may broadcast a high barring rate to be applied for a relatively long duration to block certain types of traffic from various UEs.

Of course, this standards-based mechanism is only an example, and a different type of thresholding could be used for different embodiments (e.g., a UE may be allowed to transmit only if the random value is less than or equal to the broadcast value).

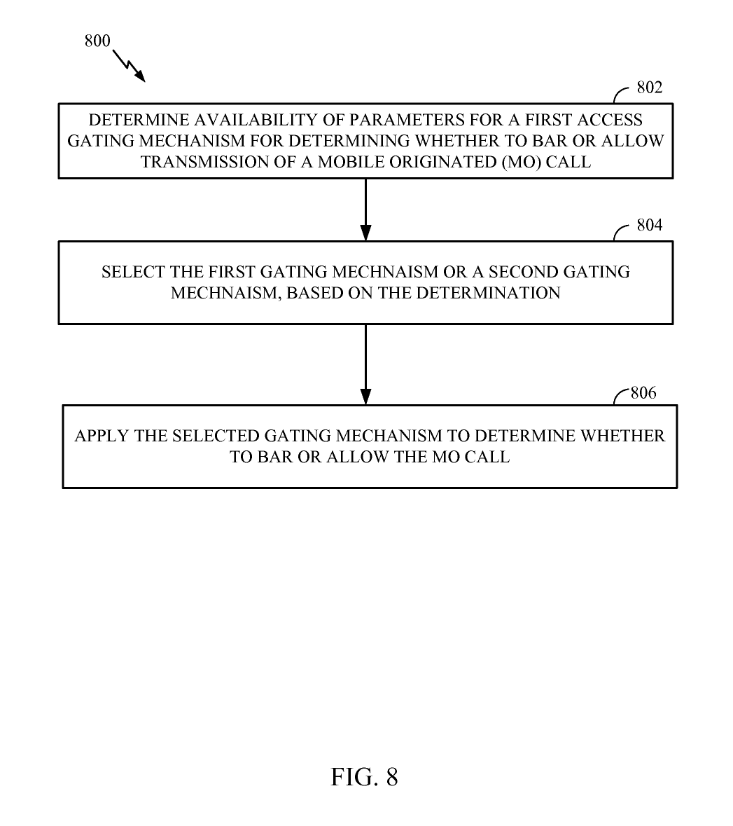

FIG. 8 illustrates example operations 800 that may be performed by a UE, in accordance with certain aspects of the present disclosure. The operations 800 may be performed by any suitable component at a UE, such as one or more of TX processor 616, controller/processor 675, and/or RX processor 670.

The operations 800 begin, at 802 by determining availability of parameters for a first access gating mechanism for determining whether to bar or allow transmission of a mobile originated (MO) call.

According to certain aspects, the parameters may be determined available if a system information block indicates barring for at least one of voice or video. For example, a SystemInformationBlockType2 may indicate ssac-BarringForMMTEL-Voice or ssac-BarringForMMTEL-Video. Additionally or alternatively, the parameters may be determined available if the UE is provisioned in memory with barring for at least one of voice or video. According to certain aspects, a UE may be provisioned with ssac-BarringForMMTEL-Voice or ssac-BarringForMMTEL-Video in nonvolatile memory.

Additionally or alternatively, the parameters may be determined available if the UE is provisioned with a list of public land mobile networks (PLMNs) PLMN that matches with a network-broadcasted PLMN. According to certain aspects, if a UE-provisioned PLMN list matches a broadcasted PLMN, a UE may assume default values for voice and video barring. That is, the UE may assume default values for ssac-BarringForMMTEL-Voice and ssac-BarringForMMTEL-Video. According to certain aspects, default values may be an ac-BarringFactor of 100 and an ac-BarringTime of 0 sec.

Operations 800 continue, at 804, by selecting the first access gating mechanism or a second access gating mechanism, based on the determination of the availability of parameters. At 806, operations 800 continue by applying the selected gating mechanism to determine whether to bar or allow the MO call.

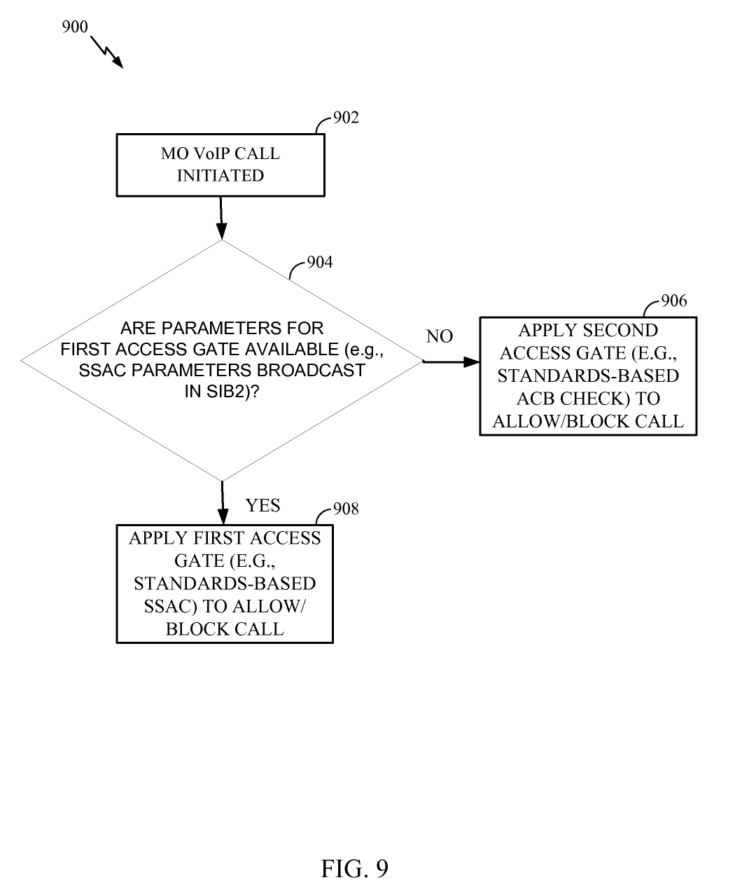

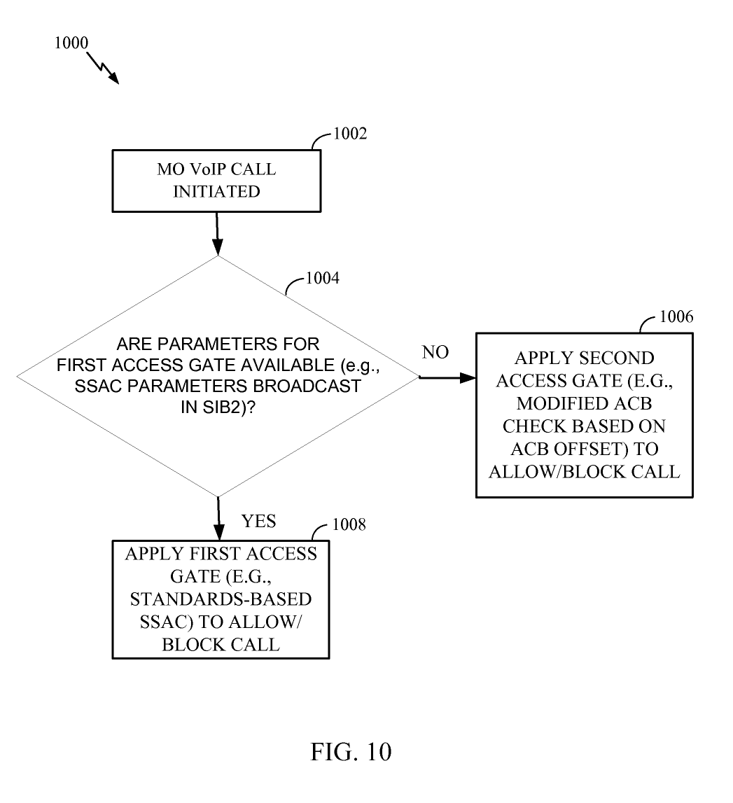

FIGS. 9 and 10 illustrate example flow diagrams that represent how a UE might perform operations 800 shown in FIG. 8.

FIG. 9 illustrates example operations 900 that may be performed by a UE, in accordance with certain aspects of the present disclosure. The operations 900 may be performed by any suitable component at a UE, such as one or more of TX processor 616, controller/processor 675, and/or RX processor 670.

The operations 900 begin, at 902, by initiating a mobile originating VoIP call. At 904, the UE determines if parameters for a first access gate are available (e.g., if SSAC parameters were broadcast in a SIB2). If parameters for the first access gate are available, the first access gate may be applied (e.g, standard SSAC) to allow or block the call, at 908. On the other hand, if parameters for the first access gate are not available, the second access gate may be applied (e.g, a standard ACB check) to allow or block the call, at 906.

As indicated, the first access gate may correspond to SSAC. Thus, the operations in FIG. 9 may be considered an SSAC-only approach, meaning if SSAC parameters are available, SSAC is applied and an ACB check is not performed. If the SSAC check allows VoLTE call, the ACB check for MO data may be skipped. If the SSAC check blocks the VoLTE call, the call is blocked. If SSAC parameters are not broadcast, the UE may performs standards based ACB check for MO data.

FIG. 10 illustrates example operations 1000 that may be performed by a UE based on a modified ACB check, in accordance with certain aspects of the present disclosure. The operations 1000 may be performed by any suitable component at a UE, such as one or more of TX processor 616, controller/processor 675, and/or RX processor 670.

The operations 1000 begin, at 1002, by initiating a mobile originating VoIP call. At 1004, the UE determines if parameters for a first access gate are available (e.g., if SSAC parameters were broadcast in a SIB2). If parameters for the first access gate are available, the first access gate may be applied (e.g, standard SSAC) to allow or block the call, at 1008.

On the other hand, if parameters for the first access gate are not available, a second access gate may be applied, for example, based on a modified ACB check, to allow or block the call, at 1006.

According to certain aspects, the modified ACB check may be based on an additional offset value (e.g., as applied to a broadcast barring rate). For example, the UE may allow for a configuration parameter called “VoLTE ACB offset”. This parameter may take a range of +ve and −ve values (e.g., in a range of [+10, −10]). The value configured may be used to offset the ACB probability factor (barring rate), in some manner, by the configured value. For example, if the value configured is “−2”, and the probability factor for the UE's AC is 0.8, the actual probability factor value used for the ACB check may be 0.6. In this manner, this approach may not necessarily depend on operator deployment of SSAC, and may work without it.

The techniques presented herein may provide an access mechanism for a UE to determine that a certain call is of type VoLTE/VT, determining whether an application level access control check has been performed and, in some cases, omit an access class barring check for PS data if the application level access control check has been performed. As described above, a modified access class barring check for PS data may be performed, in some cases, if the application level access control check has not been performed.

According to certain aspects of the present disclosure, an apparatus for wireless communication may include means for performing various functions as described herein. In one aspect, the aforementioned means may be a processor or processors and associated memory in which embodiments reside, such as are shown in FIG. 6, and which are configured to perform the functions recited by the aforementioned means. According to certain aspects, the aforementioned means may be a transmitter or receiver, such as are shown in FIG. 6, and which are configured to perform the functions recited by the aforementioned means. In another aspect, the aforementioned means may be a module or any apparatus configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

As used herein, a phrase referring to “at least one of a list of items refers to any combination of those items, including single members. As an example, “at least one of: a, b, or c” is intended to cover: a, b, c, a-b, a-c, b-c, and a-b-c.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method for wireless communications by a user equipment (UE), comprising:
determining availability of parameters for a first access gating mechanism for determining whether to bar or allow transmission of a mobile originated (MO) call;
selecting the first access gating mechanism or a second access gating mechanism, based on the determination; and
applying the selected access gating mechanism to determine whether to bar or allow the MO call.

2. The method of claim 1, wherein parameters are determined available if at least one of:
a system information block indicates barring for at least one of voice or video;
the UE is provisioned in memory with barring for at least one of voice or video; or
the UE is provisioned with a list of public land mobile networks (PLMNs) PLMN that matches with a network-broadcasted PLMN.

3. The method of claim 1, wherein the selecting comprises:
selecting the first access gating mechanism if parameters for the first access gating mechanism are available; or
selecting the second access gating mechanism if parameters for the first access gating mechanism are not available.

4. The method of claim 1, wherein the first access gating mechanism comprises a service specific access control (SSAC) mechanism.

5. The method of claim 1, wherein the second access gating mechanism comprises a type of access class barring (ACB) mechanism.

6. The method of claim 5, further comprising:
obtaining an offset value; and
determining whether to bar or allow the MO call based on a broadcast value and the offset value, when the second access gating mechanism is selected.

7. An apparatus for wireless communications, comprising:
means for determining availability of parameters for a first access gating mechanism for determining whether to bar or allow transmission of a mobile originated (MO) call;
means for selecting the first access gating mechanism or a second access gating mechanism, based on the determination; and
means for applying the selected access gating mechanism to determine whether to bar or allow the MO call.

8. The apparatus of claim 7, wherein parameters are determined available if at least one of:
a system information block indicates barring for at least one of voice or video;
the UE is provisioned in memory with barring for at least one of voice or video; or
the UE is provisioned with a list of public land mobile networks (PLMNs) PLMN that matches with a network-broadcasted PLMN.

9. The apparatus of claim 7, wherein the means for selecting comprises:
means for selecting the first access gating mechanism if parameters for the first access gating mechanism are available; or
means for selecting the second access gating mechanism if parameters for the first access gating mechanism are not available.

10. The apparatus of claim 7, wherein the first access gating mechanism comprises a service specific access control (SSAC) mechanism.

11. The apparatus of claim 7, wherein the second access gating mechanism comprises a type of access class barring (ACB) mechanism.

12. The apparatus of claim 11, further comprising:
means for obtaining an offset value; and
means for determining whether to bar or allow the MO call based on a broadcast value and the offset value, when the second access gating mechanism is selected.

13. An apparatus for wireless communication, comprising:
at least one processor configured to:
determine availability of parameters for a first access gating mechanism for determining whether to bar or allow transmission of a mobile originated (MO) call;
select the first access gating mechanism or a second access gating mechanism, based on the determination; and
apply the selected access gating mechanism to determine whether to bar or allow the MO call.

14. The apparatus of claim 13, wherein parameters are determined available if at least one of:
a system information block indicates barring for at least one of voice or video;
the UE is provisioned in memory with barring for at least one of voice or video; or
the UE is provisioned with a list of public land mobile networks (PLMNs) PLMN that matches with a network-broadcasted PLMN.

15. The apparatus of claim 13, wherein the at least one processor configured to select is further configured to:
select the first access gating mechanism if parameters for the first access gating mechanism are available; or
select the second access gating mechanism if parameters for the first access gating mechanism are not available.

16. The apparatus of claim 13, wherein the first access gating mechanism comprises a service specific access control (SSAC) mechanism.

17. The apparatus of claim 13, wherein the second access gating mechanism comprises a type of access class barring (ACB) mechanism.

18. The apparatus of claim 17, wherein the at least one processor is further configured to:
obtain an offset value; and
determine whether to bar or allow the MO call based on a broadcast value and the offset value, when the second access gating mechanism is selected.

19. A computer program product for wireless communications, comprising a computer-readable medium having instructions stored thereon, the instructions executable by one or more processors for:
determining availability of parameters for a first access gating mechanism for determining whether to bar or allow transmission of a mobile originated (MO) call;
selecting the first access gating mechanism or a second access gating mechanism, based on the determination; and
applying the selected access gating mechanism to determine whether to bar or allow the MO call.

20. The computer program product of claim 19, wherein parameters are determined available if at least one of:
a system information block indicates barring for at least one of voice or video;
the UE is provisioned in memory with barring for at least one of voice or video; or
the UE is provisioned with a list of public land mobile networks (PLMNs) PLMN that matches with a network-broadcasted PLMN.

21. The computer program product of claim 19, wherein the code for selecting comprises:
code for selecting the first access gating mechanism if parameters for the first access gating mechanism are available; or
code for selecting the second access gating mechanism if parameters for the first access gating mechanism are not available.

22. The computer program product of claim 19, wherein the first access gating mechanism comprises a service specific access control (SSAC) mechanism.

23. The computer program product of claim 19, wherein the second access gating mechanism comprises a type of access class barring (ACB) mechanism.

24. The computer program product of claim 23, wherein the non-transitory computer-readable medium further comprises:
code for obtaining an offset value; and
code for determining whether to bar or allow the MO call based on a broadcast value and the offset value, when the second access gating mechanism is selected.
